(19) United States
(12) Patent Application Publication
(10) Pub. No.: US 2023/0082233 A1
(43) Pub. Date: Mar. 16, 2023

(54) Device for recording encrypting and saving videos on external data storage device

(71) Applicants: Meir Dahan, Adi (IL); Eliahu Antopolsky, Zichron Yaakov (IL)

(72) Inventors: Meir Dahan, Adi (IL); Eliahu Antopolsky, Zichron Yaakov (IL)

(21) Appl. No.: 17/472,627

(22) Filed: Sep. 11, 2021

(51) Int. Cl. G06F 21/10; H04N 5/77; G06F 3/16; G06F 21/60; G06F 3/06

(52) U.S. Cl. CPC G06F 21/10; H04N 5/77; G06F 3/16; G06F 21/602; G06F 3/0623; G06F 3/0655; G06F 3/0679; G06F 2221/0731

(57) ABSTRACT

A device for documenting and encrypting a face to face personal meeting that includes a casing, a connecting unit that can communicate with external data storage device, a camera or microphone, an encryption subsystem, a decryption subsystem, and a personal key reader that is capable to identify personal keys of participants of the meeting. The device can encrypt the video that can be decrypted by using the personal keys of the participants. The device can save the encrypted video only in external storage device that communicates with the connecting unit while the camera shoots the video, and it is saved with information of the participants' identified personal keys. The decryption subsystem can decrypt the encrypted video when external storage device in which the encrypted video is saved communicates with the connecting unit and when the reader identifies the identified personal keys of the participants.

### FIELD OF THE INVENTION

The present invention relates to a device for recording and encrypting videos of face to face personal meetings that are saved on an external data storage device.

### BACKGROUND OF THE INVENTION

In many cases disputes arise as to the nature and the content of meetings that were held in the past, mainly when such meetings were not recorded and were between two persons in private. Experience of life teaches us that in many such cases one participant alleges ex post facto that during the meeting certain events have happened or certain spoken words have been told and on the other hand the other participant alleged differently. Systems for meeting documentation which include audio and video recording are known in the art and can provide satisfactory solution in a wide range of cases. However, such a solution is not sufficient in special cases, when the participants have interest to record the meeting and in the same time they are also interested in the safety of documentation, in the meaning that no one—even one of the participant—would have an access to the documentation without specific consent of all the participant of that meeting.

Such kind of meetings can be for example: meetings between psychologist or psychiatric and patient in which the patient discloses private information that he does not want that this information would be disclosed to others; meetings between attorney and his client when they discuss sensitive matters; meetings for medical treatment such as dental, physiotherapy and other kinds of medical treatment; and also sexual meetings and the like. The expression “personal meeting” or “face to face personal meeting” in this paper and in the claims relates to all of those kind of meetings, which express meetings in which the participants are together in the same physical location at the same time when they can directly see each other and hear each other without aids of any kind of external equipment beside their eyes and ears.

There are many sound and video recording devices that are not, however, equipped with any components that prevent unauthorized access to the documentation. The present invention offers a solution for people, mainly service providers, for example therapists, doctors, lawyers and the like who wish to record their personal meeting with their clients in a way that will prevent any access to the recording unless such access is authorized by all of the meeting's participants and by the positive action of each and every one of the participants, and also that this recording system may be used by these service providers with many patients, clients and the like. The present invention also discloses some additional embodiments.

### LIST OF DRAWINGS

The intention of the drawings attached to the application is not to limit the scope of the invention and its application. The drawings are intended only to illustrate the invention and they constitute only one of its many possible implementations.

FIGS. 1A and 1B describe schematically the device (1) and its main components.

FIG. 2 describes schematically the device (10) and its main components.

FIG. 3 describes schematically the device (100) and its main components.

FIG. 4 describes schematically the smartphone (1000) and its main components.

### THE INVENTION

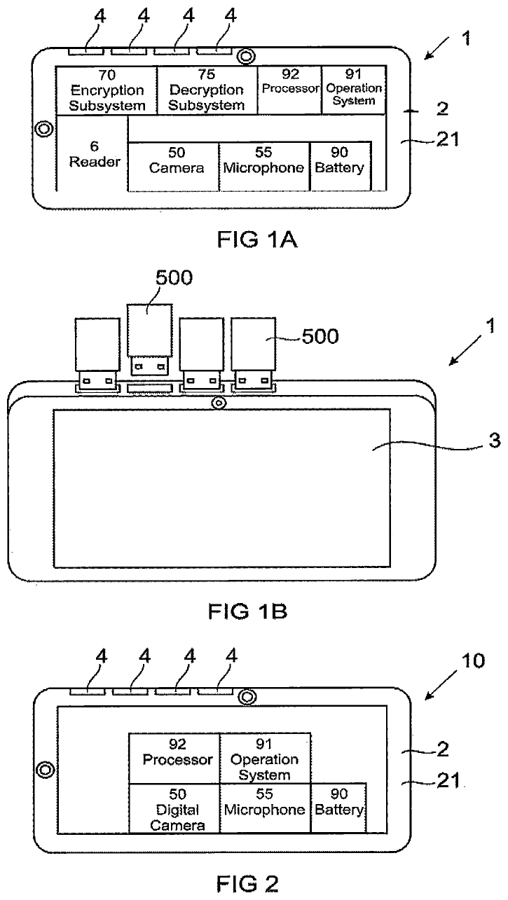

The main object of the present invention is to provide a device (1) for documenting in encrypted form a face to face personal meeting that includes a casing (2), a connecting unit (4) that is designed to be electronically communicated with external data storage device (500), a camera (50) or a microphone (55), a personal key identification reader (6), an encryption subsystem (70), and a decryption subsystem (75). The device (1) may also include a touch screen (3) similar for example to touch screens of smartphones. The connecting unit (4), the camera (50), the microphone (55), the encryption subsystem (70), and the decryption subsystem (75) are positioned inside the casing (2) in an interior space defined by the casing. FIGS. 1A and 1B describe schematically the device (1) with its main components.

The casing (2) may be for example like standard known casings of smartphones and it is even recommended to implement the disclosed invention using a casing in a sizes and dimensions such as standard smartphones known in our days. The connecting unit (4) can be for example a component such as Bus ports in a type of USB ports for example that are commonly used in our days in connection with electronic devices or a component that based on Bluetooth communication or Near-Field Communication and in such cases the external storage device will be accordingly. The connecting unit (4) is designed to be electronically communicated with the external data storage device (500) (in short hereinafter “external storage device”) that can be for example a USB Flash drive in which it is possible to save the video files. It is possible and preferably that the device (1) will have several connecting units (4) so that few participants can insert their external storage devices into the connecting units and to have in their possession (in their own USB Flash drive) the saved encrypted video. It is possible to use an adapter with one leg that can be inserted into the connecting unit or communicated with the connecting unit and that adapter has several connecting units on it for multiple external storage devices.

The device (1) is designed in a way that the connecting unit (4), the camera (50) or the microphone (55), the encryption subsystem (70), and the decryption subsystem (75) are positioned inside an interior space (21) that is defined by the casing.

The personal key identification reader (6) (hereinafter in short “reader”) is capable to identify personal keys of participants of the face to face personal meeting. The reader (6) can be for example a biometric identification reader such as a fingerprint reader, a face recognition reader, a retina identification reader, an iris identification reader, or a voice recognition reader. In such cases, the personal key can be a biometric feature, such as a face characteristic, voice, fingerprint, retina and other kind of features. The reader may be based on typing a code or magnetic cards and the like.

The camera (50) is designed to shoot a video of the face to face personal meeting (hereinafter in short “meeting”) and the microphone (55) is designed to execute a voice recordation of the meeting. In this paper and in the claims we use the word “shooting” and “video” but in this paper and in the claims it means also the action of taking a photo and a photo accordingly. A typical standard smartphone digital camera for example can be used as the camera of the device. The video may be displayed on the touch screen (3) in real time in the same ways when making a video in smartphones. The device can be with a camera and microphone, but there is an option to implement the invention only with microphone, and such device can be less expensive and fit for kind of meeting that the visual aspect is not so important such as a meeting between a lawyer and his client, a psychologist and his patient or in cases that the user is unlikely to agree to shoot videos such as in a massage therapy where a voice recordation may be enough to prove if something wrong happened during the massage and the like.

The encryption subsystem (70) is designed to encrypt the video or the voice recordation in such a way that the encrypted video or the encrypted voice recordation is configured to be decrypted by the decryption subsystem by using personal keys of participants that were identified by the personal key identification reader before the camera shoots the video or before the microphone executes the voice recordation. It should be noted that there is no necessity that all of the participants will insert their personal keys into the device. It can be a case when there are five participants but it is enough to the opinion on those five person that only two participants will be the guards and controllers of the encrypted video and only these two participants can insert their personal keys, and it is possible that a person that is not a participant of that meeting will insert his personal key and to become a guardian. It is also possible that only one person will insert his personal key. For example, in a massage therapy it seems enough that the client will insert her personal key and the SPA will keep the encrypted voice recordation so that the client will feel safe and comfort and in any future allegation they SPA will bring the USB and the client will give his fingerprint for opening the encrypted voice recordation and the judge can hear the voice recording. The term participant refers therefore to the persons who inserted their personal keys for that shooting.

The device (1) is designed and capable to save the encrypted video or the encrypted voice recordation only and solely in external storage device that is electronically communicated with the connecting unit while the camera shoots the video or while the microphone executes the voice recordation.

The participants aware of the fact that the video or the voice recordation cannot be saved inside the device (1) but only in their external storage device (their USB flash device), and this fact is likely to make them feel more comfortable as to the safety and privacy of the documentation. The encrypted video is saved in the external data storage devices with information as to the identified personal keys of the participants, means the participants or the person or persons who inserted their personal keys into the device before the shooting the video or before executing the voice recordation. This fact makes it clear to the participants that the saved video and the saved voice recordation is encrypted and cannot be viewed without their future consent.

The decryption subsystem (75) is designed to decrypt the saved encrypted video or the saved encrypted voice recordation when an external data storage device in which the saved encrypted video or the saved encrypted voice recordation is saved is electronically communicated with the connecting unit and this only when the personal key identification reader identifies all the identified personal keys of all participants.

It is possible that before shooting the video or executing the voice recordation the participants (or one of them or few of them) insert their personal keys (fingerprint for example) to the personal key identification reader (6) and then they may activate the camera that shoots the video. The streaming video is encrypted and saved in the external USB flash drivers that are connected at that time with the connecting unit (4).

The term “encrypted” in this paper and in the claims means that the video or the voice recordation is encrypted or scrambled or undergoing a process that disable it from being opened and viewed, but only by using the personal keys that were inserted before shooting the video or executing the voice recordation. The term “decrypted” in this paper and in the claims means that the video or the voice recordation can be opened and viewed in the screen of the device and also with a possible option to enable the participants to cancel the encryption permanently.

The encrypted video or the encrypted voice recordation is saved in the external storage device and the decryption of this saved video can be done only by using the personal keys of the participants of that face to face personal meeting as inserted prior the shooting of that video.

It is clear from the above explanation that decryption and access to the saved encrypted video can be done only by consent of the participants of that face to face personal meeting, by using all of their personal keys. Each participant of that specific face to face personal meeting is aware of the fact that the saved video is locked and inaccessible to any person without using his personal key.

People can document their face to face personal meeting using their biometric features as personal keys and if after that meeting one of the participants alleged that during the meeting something wrong had happened, or in any other case of disagreeing as to the nature of the meeting, the participants can together view the video, possible in a presence of a Judge, and by that to resolve the dispute.

The device (1) may include the digital camera (50) that inherently includes a microphone, or that the device (1) will be aimed for voice recordation only and then it can have a microphone (55) instead of a camera, and the resulting will be a voice recordation rather than a video.

The device (1) may also include a power source (90) such as an inner chargeable battery as now used in smartphones, an operation system (91) that can be featured on the touch screen or buttons that enable the user to activate the camera and the microphone, to insert the personal keys, to give a command to view or decrypt the video on the screen and the like. It is preferably that the device (1) may have an inner processor (92) in which components of the device may be stored, such as the operation system, and also the encryption and decryption subsystems.

The second embodiment of the present invention refers to a device (10) for documenting meetings that comprises the casing (2), the connecting unit (4) that is designed to be electronically communicated with external data storage device (500), and the camera (50) that is capable to shoot the video of the face to face personal meeting. The connecting unit and the camera are positioned inside the casing. The device is designed and capable to save the video only and solely in the external data storage device that is electronically communicated with the connecting unit while the camera shoots the video. This deice (10) does not include the personal key identification reader, the encryption subsystem, and the decryption subsystem.

This device (10) can address a variety of situations where there is a requirement to record a meeting in a way that each participant can take immediately at the end of the meeting a USB with documentation of the meeting, without any need to transfer copies by email or other inconvenient means. For example, a situation where an examiner team leader is having a meeting with three examiners. Each participant inserts its personal USB into the appropriate port, they activate the recording (video or voice recordation), and the documentation is kept for each participant in his own USB that he can take with himself immediately at the end of the session. There is currently no device that provides a solution to such situations. The device (10) can save retrospective questions about what was said or not said at the meeting and obviates the need for handwritten recording during the meeting, which interferes with concentration and is time consuming. FIG. 2 describes schematically the device (10) with its main components.

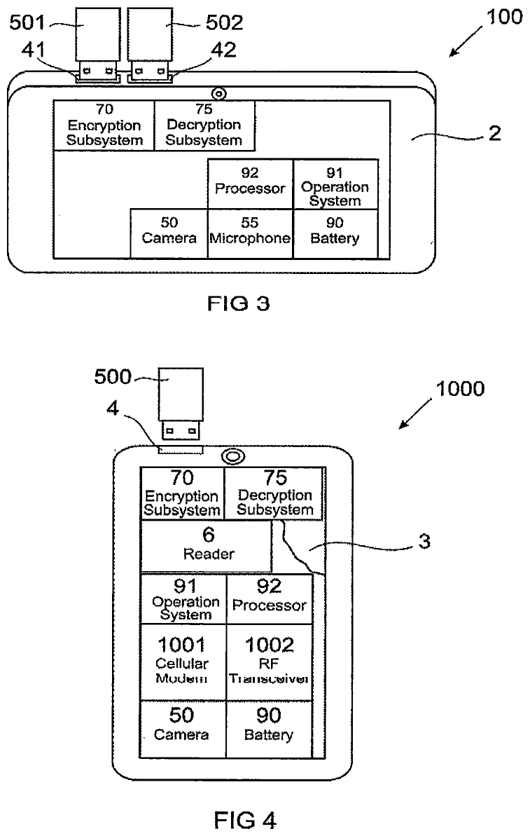

The third embodiment of the present invention refers to a device (100) for documenting in encrypted form a face to face personal meeting that comprises a casing (2), a first connecting unit (41) and a second connecting unit (42) that are designed to be electronically communicated with external data storage devices (500), a camera (50) that is capable to shoot a video of the face to face personal meeting or a microphone (55) that is capable to execute a voice recordation of the face to face personal meeting, an encryption subsystem (70), and a decryption subsystem (75). FIG. 3 describes schematically the device (100) with its main components.

The first and the second connecting units (41) (42), the camera (50) or the microphone (55), the encryption subsystem (70), and the decryption subsystem (75) are positioned inside the casing (2).

The encryption subsystem is designed to encrypt the video or the voice recordation when two external data storage devices (501) (502) are electronically communicated with the first connecting unit and with the second connecting unit while the camera shoots the video or while the microphone executes the voice recordation.

The device is designed and capable to save the encrypted video or the encrypted voice recordation only and solely in the external data storage devices that are electronically communicated with the first and the second connecting units while the camera shoots the video or while the microphone executes the voice recordation.

The device is designed to save the encrypted video or the encrypted voice recordation in the external storage device that is electronically communicated with the first connecting unit with first part code information and in the external storage device that is electronically communicated with the second connecting unit with second part code information.

The encrypted video or the encrypted voice recordation is configured to be decrypted by the decryption subsystem when an external data storage device in which the encrypted video or the encrypted voice recordation is saved with the first part code information and an external data storage device in which the encrypted video or the encrypted voice recordation is saved with the second part code information are electronically communicating at the same time with the first and the second connecting units.

In the fourth embodiment we implement the invention in a smartphone, in other words using a smartphone as the basis for the device: A smartphone (1000) that is configured for documenting in encrypted form a face to face personal meeting that comprises all the components that are customary to be inside a smartphone in our days, such as a processor with flash memory (92), cellular modem (1001), RF transceiver (1002), touch screen (3), a camera (50) that is capable to shoot a video of the face to face personal meeting, and a personal key identification reader (6) that is capable to identify personal keys of participants of the face to face personal meeting. FIG. 4 describes schematically the smartphone (1000) with its main components.

The smartphone (1000) is further includes a connecting unit (4) that is designed to be electronically communicated with external data storage device (500), an encryption subsystem (70), and a decryption subsystem (75).

The encryption subsystem is designed to encrypt the video when an external data storage device (500) is electronically communicated with the connecting unit while the camera shoots the video.

The smartphone (1000) is designed and capable to save the encrypted video only and solely in the external data storage device that is electronically communicated with the connecting unit while the camera shoots the video. It means that in a regular use when there is no external storage device that comminutes with the connecting unit then the smartphone works normally as known today. But, when the user inserts the external storage device to the connecting unit then the smartphone is disabled to save any videos on its memory but only on the external storage device. So if the public knows that a particular model of smartphone includes this feature, then whenever the participants see that there is a USB connected to the connecting unit of the smartphone then they are calm and confident that the video will only be saved on that USB means on that external data storage device.

The encryption subsystem is designed to encrypt the video in two alternative ways: The first one, in such a way that the encrypted video is configured to be decrypted by the decryption subsystem by using personal keys of participants that were identified by the personal key identification reader before the camera shoots the video or, the second one, by using a unique identifier of the smartphone.

The encrypted video is saved in the external data storage device with information as to the identified personal keys of said participants (first option) or with information as to the unique identifier of the smartphone (second option).

The decryption subsystem is designed to decrypt the saved encrypted video when an external data storage device in which the encrypted video is saved is electronically communicated with the connecting unit, and when the personal key identification reader identifies the identified personal keys of all participants or when the decryption is done in the smartphone that was used to shoots the video.

These two options of encryption and decryption address two different needs. The first one fits when few participants want to make a video and want to have the option to view it in any smartphone in that kind or that has that feature (the manufacturer can implement this invention in several models of it smartphones). The second one, fits when a person wants to shoot video or to take photos and he is afraid that hackers or any other person may still these files from his smartphone and view it and show it to other people. This second option, disable the possibility to view these files in another devices but only in that specific device of the user due to the fact that a unique identifier of his device is used for the decryption of the video.

1-3. (canceled)

4. A device that is designed to shoot a video or to take a photo or to execute a voice recordation and that is designed to save the video or the photo or the voice recordation simultaneously and solely in at least two external USB flash drives, comprising: a casing, at least two USB ports that are designed to communicate electronically with the at least two external USB flash drives, and a camera that is positioned inside the casing and that is designed to shoot the video or to take the photo on a microphone that is positioned inside the casing and that is designed to execute the voice recordation; wherein the device is designed to save the video or the photo or the voice recordation solely in the at least two external USB flash drives while the at least two external USB flash drives are inserted inside the at least two USB ports and while the camera is shooting the video or taking the photo or while the microphone executing the voice recordation.
